(19) United States
(12) Patent Application Publication
(10) Pub. No.: US 2019/0054529 A1
(43) Pub. Date: Feb. 21, 2019

(54) Method and machines for manufacturing at least one piece made of at least one ceramic and/or metallic material by the technique of additive manufacturing

(71) Applicant: S.A.S 3DCeram-Sinto, LIMOGES (FR)

(72) Inventors: Richard Gaignon, Saint-Vrain (FR); Christophe Chaput, Le Palais-Sur-Vienne (FR)

(21) Appl. No.: 15/999,032

(22) Filed: Aug. 20, 2018

(30) Foreign Application Priority Data
Aug. 18, 2017 (FR) 1770869

(51) Int. Cl. B22F 3/00; B22F 1/00; B23K 26/362; C04B 35/626; C04B 35/634

(52) U.S. Cl. CPC B22F 3/008; B22F 1/0059; B33Y 10/00; C04B 35/6269; C04B 35/634; B23K 26/362

(57) ABSTRACT

A computer model of the at least one piece to be manufactured is built up by computer-aided design; on a working tray, the piece is formed from a ceramic or metallic photocurable composition. At least one sacrificial organic material different from the basic CPCb or MPCb is prepared; successive CPCb or MPCb layers are formed, the following steps being carried out to form hollow parts of the piece and/or to insert at least one part into another ceramic or metallic material: forming a recess in a cured CPCb or MPCb layer from the upper surface thereof; depositing in the recess a MOS or CPCa or MPCa to fill; curing the MOS or CPCa or MPCa in the recess to obtain a hard horizontal surface at the same level as the nearby CPCb or MPCb layer.

The present invention relates to a method and a machine for manufacturing pieces by the technique of additive manufacturing.

Especially, these pieces are pieces made of ceramic or metallic material obtained in the green state, then subjected to cleaning, debinding and sintering operations in order to obtain the finished ceramic or metallic pieces.

### BACKGROUND OF THE INVENTION

The technique of additive manufacturing, also called stereolithography, generally comprises the following steps, in order to obtain such green ceramic pieces:
building, by computer-aided design, a computer model of the piece to be manufactured, the sizes of this model being larger than those of the piece to be manufactured so as to anticipate a shrinking of the ceramic material during the manufacturing of the piece; and
manufacturing the piece by means of the technique of additive manufacturing, technique comprising the following steps:
   forming, on a rigid support or on a piece being manufactured, a first layer of a photocurable composition generally comprising at least one ceramic material, at least one dispersant, at least one photocurable monomer and/or oligomer, at least one photoinitiator and at least one plasticizer;
   curing the first layer of the photocurable composition by irradiation according to a pattern defined from the model for said layer, forming a first stage;
   forming, on the first stage, a second layer of the photocurable composition;
   curing the second layer of the photocurable composition by irradiation according to a pattern defined for said layer, forming a second stage, this irradiation being performed by laser scanning of the free surface of the spread photocurable composition or by a light emitting diode projection system;
   optionally, repeating the above-mentioned steps in order to obtain the green piece.

Then, in order to obtain the finished piece, the green piece is cleaned in order to remove the uncured composition; the cleaned green piece is debinded; and the cleaned and debinded green piece is sintered in order to obtain the finished piece.

The same process is undertaken in the case of a metallic material.

If the manufacturing using this technology of pieces of ceramic or metallic material having a simple shape is well controlled, manufacturing pieces which have a complex shape and/or composition presents difficulties.

“Complex-shaped pieces” especially means pieces which comprise three-dimensional geometry passages (or channels), such passages being difficult to clean properly because there are not tools appropriate for these geometries.

“Pieces having a complex composition” especially means pieces made of several ceramic or metallic materials.

The Applicant Society has discovered that such complex pieces could be obtained by making one or more recesses in the layers of photocured ceramic or metallic composition, these recesses being filled, in order to complete the layer thus provided with recess(es), with a flowable composition, then to be cured, in order to form a complete layer again, on which the next photocurable ceramic or metallic composition layer will be spread.

The flowable composition may be another photocurable ceramic or metallic composition, which will allow to form multi-material pieces, or a curable sacrificial material, which will be destroyed during the debinding process, releasing the hollow parts or the passages made in the pieces without requiring a tool or a cleaning chemical product to be entered thereinto.

### BRIEF SUMMARY OF THE INVENTION

Therefore, the present invention first relates to a method for manufacturing at least one piece made of at least one material selected among the ceramic materials and the metallic materials by the technique of additive manufacturing, said at least one piece being formed in the green state and then being caused to be subjected to cleaning, debinding and sintering operations, said method comprising the following steps:
(1) building, by a computer-aided design, a computer model of the at least one piece to be manufactured;
(2) forming, on a working tray, said at least one piece to be manufactured, which is based on a ceramic or metallic photocurable composition (CPCb or MPCb) comprising:
   a mineral part consisting of at least one powdered ceramic material or of at least one powdered metallic material; and
   an organic part able to be destroyed by heating during the debinding and comprising at least one photocurable monomer and/or oligomer and at least one photoinitiator;
      characterised in that:
   at least one material different from said basic CPCb or MPCb, able to flow and to be cured once flowed, is prepared, said material being a sacrificial organic material (SOM) able to be destroyed by heating during the debinding process or an additional ceramic or metallic composition CPCa or MPCa;
   for the building of said at least one piece, on the working tray, successive CPCb or MPCb layers are formed, which are each time caused to be cured by irradiation according to the pattern previously defined from the model for said layer, the following steps being carried out to form hollow parts of the piece and/or to insert at least one part made of another ceramic or metallic material:
      forming, by machining, at least one recess in at least one cured CPCb or MPCb layer from the upper surface thereof;
      depositing in said at least one recess a SOM or CPCa or MPCa in order to fill it/them;
      curing the SOM or CPCa or MPCa placed in said at least one recess in order to obtain a hard horizontal surface at the same level as the nearby CPCb or MPCb layer,
   each time one or more recesses is or are formed, this/these one(s) being defined according to the at least one pattern previously defined from the computer model, and its (their) depth(s) being selected to ensure the continuity of the at least one piece to be manufactured,
   one or more recesses being also able to be formed in a part of the layer made of a CPCa or MPCa in order to insert another CPCa or MPCa thereinto,
      and, once the cured layers are stacked up, one or more green pieces are obtained, which can be subjected to a cleaning operation in order to remove the at least one uncured parts, then to a debinding operation and to a sintering operation.

The ceramic materials are the powdered sinterable ceramic materials selected in particular among alumina (Al₂O₃), zirconia (ZrO₂), zirconia-reinforced alumina, alumina-reinforced zirconia, zircon (ZrSiO₄), silica (SiO₂), hydroxyapatite, zircon-silica (ZrSiO₄+SiO₂), silicon nitride, tricalcium phosphate (TCP), aluminum nitride, silicon carbide, cordierite and mullite.

The metallic materials are the powdered sinterable metallic materials selected in particular among pure metals, such as Al, Cu, Mg, Si, Ti, Zn, Sn, Ni . . . , their alloys and the mixtures of pure metals and alloys thereof.

The recesses may need to be formed through the entire thickness of a cured layer of CPCb or MPCb or over a height less than the height of a layer. They may also need to be formed over a height greater than the thickness of a layer, for example over a height equal to the height of several layers previously spread.

When the at least one piece to be built up is provided with hollow parts, these ones have to lead to the outside surface in order for the SOM to be able to flow out during the debinding process.

It is possible to use a CPCb or a MPCb having a pasty consistency which is spread in layers by scraping or a suspended CPCb or MPCb which is applied by dipping the tray into a bath of said suspension so as to each time form the CPCb or MPCb layer to be cured, and by scraping the layer thus formed.

It is possible to use, as a SOM,
a photocurable material comprising at least one photocurable monomer and/or oligomer and at least one photoinitiator; or
a plastic material which is thermofusible in order to be flowable, particularly to be flowable under pressure, in a recess and to be cured when returning to room temperature.

Such thermosetting plastic materials are especially selected among acrylonitrile-butadiene-styrene (ABS) copolymers, polycarbonates (PC)+ABS, polycarbonates PC-ISO, polyetherimides, polyphenylsulfones, Nylon, polyvinyl alcohol, thermoplastic polyurethane, copolyesters, polypropylene and polylactic acid.

“Ceramic or metallic photocurable compositions, CPCa or MPCa, different from the CPCb or MPCb composition, respectively” means not only compositions which have a different chemical nature, but also compositions which can have the same chemical nature but which can have different physical properties, such as density, which cannot be obtained with a single spreading system.

For the forming of the at least one recess, a mechanical machining can be carried out. It is also possible to carry out a laser machining, especially under the conditions of setting the laser power between 1 and 3 watts and the laser displacement speed between 1 and 100 millimetres per second.

Likewise, at each machining step, the debris can be blown and sucked at the same time as said machining is carried out.

The SOM or the CPCa or the MPCa can be applied in the at least one recess by a dispensing nozzle.

The curing can be carried out by laser irradiating of each SOM or CPCa or MPCa layer under the conditions of setting the laser power between 70 and 700 milliwatts and a laser displacement speed between 1,000 and 6,000 millimetres per second, and of photocurable SOM layers placed in the recesses.

The present invention also relates to a machine for manufacturing at least one piece made of at least one material selected among the ceramic materials and the metallic materials by the method using the technique of additive manufacturing as defined above, characterised in that it comprises:
a frame surrounding a working tray comprising a working surface;
means for supplying and spreading in layers, on the working tray, a basic ceramic or metallic photocurable composition (CPCb or MPCb);
machining means able to form at least one recess in a photocured CPCb or MPCb layer from the upper part thereof;
means for blowing and sucking the debris resulting from said machining;
means for filling the at least one recess formed in each layer of photocured CPCb or MPCb in order to complete the layer thus provided with recess(es) by a sacrificial organic material (SOM) or a ceramic or metallic photocurable composition (CPCa or MPCa) able to flow;
irradiation means arranged above the working surface and able to irradiate, in order to cure it, each layer of CPCb or MPCb once spread, and to irradiate, in order to cure it, the SOM—when this one is photocurable —, the CPCa or the MPCa once located in the recesses made in layers of cured CPCb or MPCb.

Such a machine, able to apply in layers a CPCb or MPCb in the form of a paste, can comprise a gantry (or portal frame) having at least one scraping blade and able to move onto the frame above the working surface such that the free edge of the at least one scraping blade is able to spread the layers of CPCb or MPCb paste on the working surface,

or the CPCb or MPCb being supplied by at least one dispensing nozzle moveable in front of at least one scraping blade which spreads the CPCb or MPCb into an uniform layer when passing thereon.

Such a machine, able to apply in layers a CPCb or MPCb under the form of a suspension, can comprise a tank to be filled with said suspension, in which the working tray is able to be lowered step by step in order to form thereon, at each step, a layer to be irradiated, as well as a recoater in order to ensure that the suspension is dispensed on the entire surface to be irradiated.

The means for supplying at least one SOM or CPCa or MPCa onto the working surface can be constituted by at least one dispensing nozzle moveable above a corresponding recess in order to apply the corresponding composition therein.

According to a first embodiment, the or at least one of the nozzles can be supplied with SOM or CPCb or MPCb or CPCa or MPCa by a hose connected to a tank, in particular a piston supply tank.

According to a second embodiment, the or at least one of the nozzles can be supplied with SOM or CPCb or MPCb or CPCa or MPCa by a cartridge which forms the upper part of it, which contains a stock of MOS or CPCb or MPCb or CPCa or MPCs and which is refillable from a supply tank that is mounted or not on the machine, or which, when empty, is replaceable by a full cartridge, wherein this replacement can be ensured by a robotic arm.

The or at least one of the nozzles can be moveably mounted
using a robotic arm; or
on a gantry which has both a slide allowing to move it along the horizontal axis x of the working tray and a slide allowing to move it along the horizontal axis y of the working tray; or
on a gantry having at least one scraping blade in order to allow to the displacement thereof along the horizontal advance axis x of the scraping blade, said gantry also comprising a slide allowing to move it along the horizontal axis y.

### BRIEF DESCRIPTION OF THE DRAWINGS

In order to better illustrate the subject-matter of the present invention, a particular embodiment of it will be described hereinafter, for indicative and not limiting purposes, with reference to the appended drawings.

In these drawings:

FIG. 1 is a perspective schematic view of a machine for manufacturing a green piece made of at least two ceramic materials by the technique of additive manufacturing;

FIG. 2 is, on a larger scale, a front view of the gantry for moving the nozzles for applying two different photocurable compositions; and

FIGS. 3 to 8 illustrate the successive steps for manufacturing a piece from three different photocurable compositions.

### DETAILED DESCRIPTION OF THE INVENTION

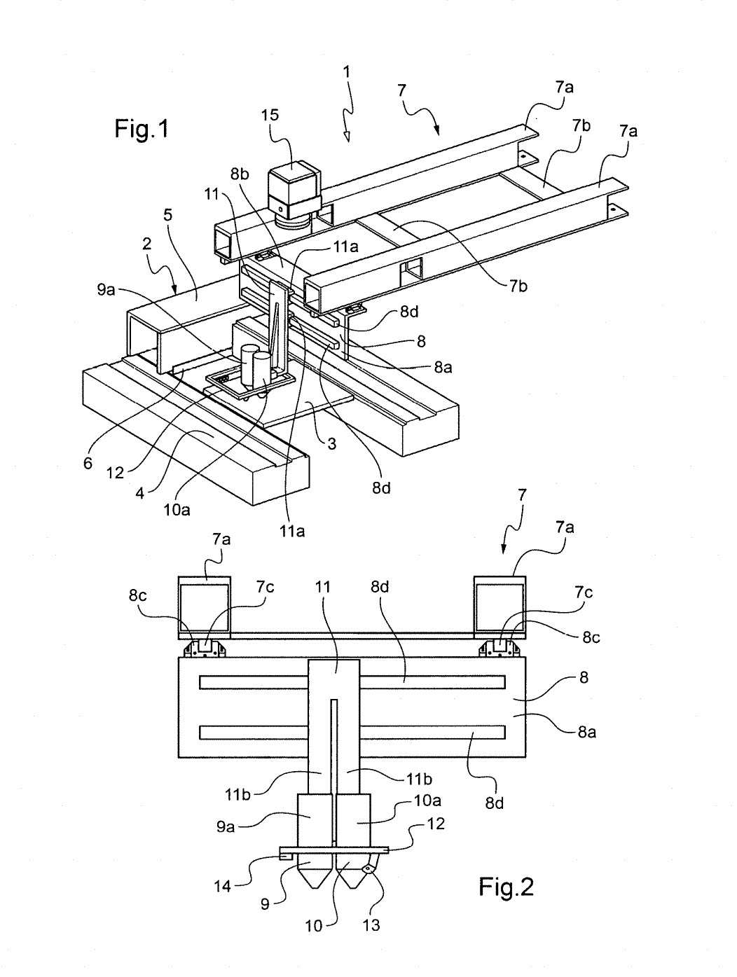

When referring to FIG. 1, it can be seen that a machine 1 for manufacturing a green piece made from three different photocurable compositions is schematically shown.

The machine 1 comprises a device 2 for scraping a layer of paste onto a working surface of a horizontal working tray 3.

The scraping device 2, slidably mounted on the frame 4 of the machine, comprises a gantry 5 carrying, at the front part thereof, a scraping blade 6 having a horizontal scraping edge.

The machine 1 also comprises a structure 7 which supports a gantry 8 for moving two nozzles 9 and 10.

The structure 7, arranged above the scraping device 2, comprises two longitudinal members 7a connected by cross members 7b. Each longitudinal member 7a carries, along its lower face, a protruding part 7c (FIG. 2).

On these protruding parts 7c, the gantry 8 for moving the nozzles 9 and 10 is slidably mounted. The gantry 8 consists in a vertical plate 8a comprising, at its upper part, a right angle part 8b which comprises members 8c cooperating with the protruding parts 7c in order for the gantry 8 to slide onto the structure 7.

The plate 8a further comprises two horizontal protruding parts 8d to which a vertical holder 11 of the nozzles 9 and 10 is slidably mounted, such holder being provided, at its rear part, with members 11a allowing this sliding.

The holder 11 has, in the example as shown, two legs 11b which are folded, at their lower part, in order for one to support the nozzle 9 and for the other to support the nozzle 10.

Each nozzle 9, 10 is topped by a rechargeable cartridge 9a, 10a, respectively, which contains a supply of photocurable composition.

Furthermore, the holder 11 carries, at its lower part, a horizontal frame 12 which surrounds the nozzles 9, 10 and to which are connected a nozzle 13 for blowing the debris, as well as a nozzle 14 for sucking the debris.

In FIG. 1, the galvanometric head 15 which directs the laser beam also appears.

Therefore, it can be seen that the scraping device 2 is mounted so as to be able to move according to the axis x, that the gantry 8 and the holder 11 are able to move according to the axis y and according to the axis x, respectively.

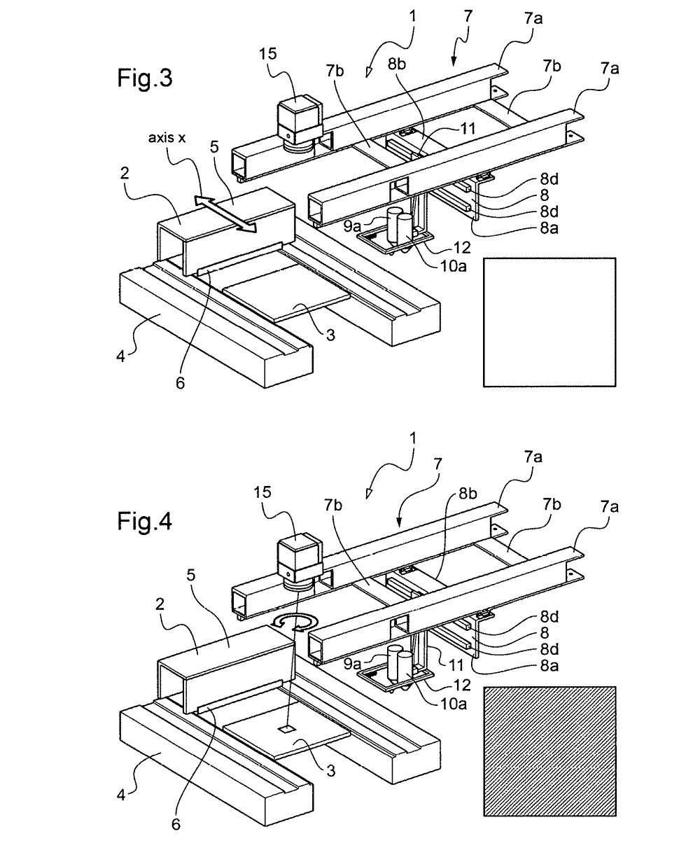

The operation of the machine which has just been described with reference to FIGS. 3 to 8 will now be described. To each of these figures is associated a square showing, on a larger scale, the top view of the part of the piece being built.

FIG. 3

A layer of ceramic paste is deposited onto the working tray 3 using the scraping device 2, which one moves according to the axis x.

FIG. 4

The layer thus deposited is caused to polymerize in the square part by applying the laser beam.

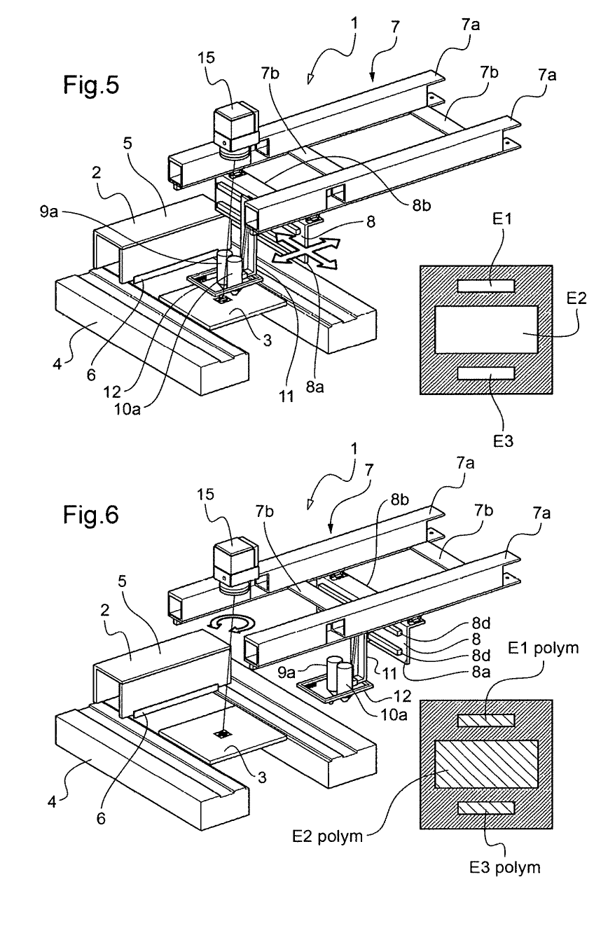

FIG. 5

The layer which has just been cured is subjected to laser machining in order to form three recesses E1, E2 and E3 therein, the gantry 8 moving according to the axis y and the holder 11, according to the axis x, this laser machining operation being carried out while blowing and sucking the debris at the same time as lasing.

FIG. 6

Using the first nozzle 9, a second photocurable composition was deposited in the recesses E1, E2 and E3. It is polymerized by applying the laser beam.

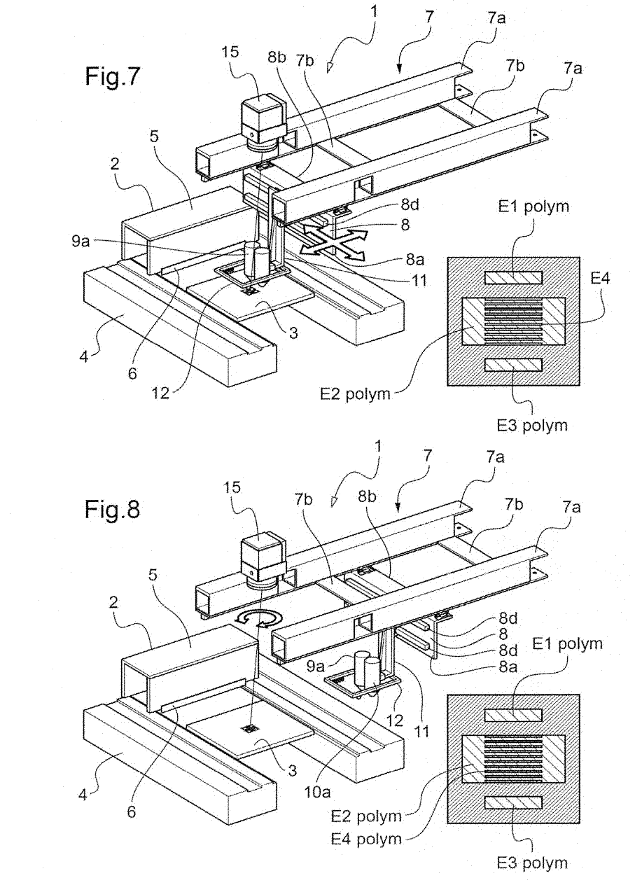

FIG. 7

The layer which has just been deposited in the recess E2 is subjected to a laser machining to form recesses E4 therein, the gantry 8 moving according to the axis y and the holder 11, according to the axis x, this machining operation being carried out while blowing and sucking the debris at the same time as lasing.

FIG. 8

Using the second nozzle 10, a third photocurable composition was deposited in the recesses E4. It is polymerized by applying the laser beam.

1—A method for manufacturing at least one piece made of at least one material selected among the ceramic materials and the metallic materials by the technique of additive manufacturing, said at least one piece being formed in the green state and then being caused to be subjected to cleaning, debinding and sintering operations, said method comprising the following steps:
(1) building, by a computer-aided design, a computer model of the at least one piece to be manufactured;
(2) forming, on a working tray, said at least one piece to be manufactured, which is based on a ceramic or metallic photocurable composition (CPCb or MPCb) comprising:
a mineral part consisting of at least one powdered ceramic material or of at least one powdered metallic material; and
an organic part able to be destroyed by heating during the debinding and comprising at least one photocurable monomer and/or oligomer and at least one photoinitiator;
characterised in that:
at least one material different from said basic CPCb or MPCb, able to flow and to be cured once flowed, is prepared, said material being a sacrificial organic material (SOM) able to be destroyed by heating during the debinding process or an additional ceramic or metallic composition CPCa or MPCa;
for the building of said at least one piece, on the working tray, successive CPCb or MPCb layers are formed, which are each time caused to be cured by irradiation according to the pattern previously defined from the model for said layer, the following steps being carried out to form hollow parts of the piece and/or to insert at least one part made of another ceramic or metallic material:
forming, by machining, at least one recess in at least one cured CPCb or MPCb layer from the upper surface thereof;
depositing in said at least one recess a SOM or CPCa or MPCa in order to fill it/them;
curing the SOM or CPCa or MPCa placed in said at least one recess in order to obtain a hard horizontal surface at the same level as the nearby CPCb or MPCb layer,
each time one or more recesses is or are formed, this/these one(s) being defined according to the at least one pattern previously defined from the computer model, and its (their) depth(s) being selected to ensure the continuity of the at least one piece to be manufactured,
one or more recesses being also able to be formed in a part of the layer made of a CPCa or MPCa in order to insert another CPCa or MPCa thereinto,
and, once the cured layers are stacked up, one or more green pieces are obtained, which can be subjected to a cleaning operation in order to remove the at least one uncured parts, then to a debinding operation and to a sintering operation.

2—The method according to claim 1, characterised in that a CPCb or a MPCb having a pasty consistency which is spread in layers by scraping, or a suspended CPCb or MPCb which is applied by dipping the tray into a bath of said suspension so as to each time form the CPCb or MPCb layer to be cured, and by scraping the layer thus formed, is used.

3—The method according to claim 1, characterised in that, as a SOM,
a photocurable material comprising at least one photocurable monomer and/or oligomer and at least one photoinitiator; or
a plastic material which is thermofusible in order to be flowable, particularly to be flowable under pressure, in a recess and to be cured when returning to room temperature,
is used.

4—The method according to claim 1, characterised in that, for the forming of the at least one recess, a mechanical machining is carried out.

5—The method according to claim 1, characterised in that, for the forming of the at least one recess, a laser machining is carried out, especially under the conditions of setting the laser power between 1 and 3 watts and the laser displacement speed between 1 and 100 millimetres per second.

6—The method according to claim 1, characterised in that, at each machining step, the debris are blown and sucked at the same time as said machining is carried out.

7—The method according to claim 1, characterised in that the SOM or the CPCa or the MPCa is applied in the at least one recess by a dispensing nozzle.

8—The method according to claim 1, characterised in that the curing is carried out by laser irradiating of each SOM or CPCa or MPCa layer under the conditions of setting the laser power between 70 and 700 milliwatts and a laser displacement speed between 1,000 and 6,000 millimetres per second, and of photocurable SOM layers placed in the recesses.

9—A machine for manufacturing at least one piece made of at least one material selected among the ceramic materials and the metallic materials by the method using the technique of additive manufacturing as defined in claim 1, characterised in that it comprises:
a frame surrounding a working tray comprising a working surface;
means for supplying and spreading in layers, on the working tray, a basic ceramic or metallic photocurable composition (CPCb or MPCb);
machining means able to form at least one recess in a photocured CPCb or MPCb layer from the upper part thereof;
means for blowing and sucking (14) the debris resulting from said machining;
means for filling the at least one recess formed in each layer of photocured CPCb or MPCb in order to complete the layer thus provided with recess(es) by a sacrificial organic material (SOM) or a ceramic or metallic photocurable composition (CPCa or MPCa) able to flow;
irradiation means arranged above the working surface and able to irradiate, in order to cure it, each layer of CPCb or MPCb once spread, and to irradiate, in order to cure it, the SOM—when this one is photocurable—, the CPCa or the MPCa once located in the recesses made in layers of cured CPCb or MPCb.

10—The machine according to claim 9, able to apply in layers a CPCb or MPCb under the form of a paste, characterised in that it comprises a gantry (5) provided with at least one scraping blade (6) and able to move onto the frame (4) above the working surface such that the free edge of the at least one scraping blade (6) is able to spread the layers of CPCb or MPCb paste on the working surface,
or the CPCb or MPCb being supplied by at least one dispensing nozzle moveable in front of at least one scraping blade which spreads the CPCb or MPCb into an uniform layer when passing thereon.

11—The machine according to claim 9, able to apply in layers a CPCb or MPCb under the form of a suspension, characterised in that it comprises a tank to be filled with said suspension, in which the working tray is able to be lowered step by step in order to form thereon, at each step, a layer to be irradiated, as well as a recoater in order to ensure that the suspension is dispensed on the entire surface to be irradiated.

12—The machine according claim 25, characterised in that the means for supplying at least one SOM or CPCa or MPCa onto the working surface are constituted by at least one dispensing nozzle moveable above a corresponding recess in order to apply the corresponding composition therein.

13—The machine according to claim 10, characterised in that the or at least one of the nozzles is supplied with SOM or CPCb or MPCb or CPCa or MPCa by a hose connected to a tank, in particular a piston supply tank.

14—The machine according to claim 5, characterised in that the or at least one of the nozzles is supplied with SOM or CPCb or MPCb or CPCa or MPCa by a cartridge which forms the upper part of it, which contains a stock of SOM or CPCb or MPCb or CPCa or MPCa and which is refillable from a supply tank that is be mounted or not on the machine, or which, when empty, is replaceable by a full cartridge, wherein this replacement can be ensured by a robotic arm.

15—The machine according to claim 15, characterised in that the or at least one of the nozzles moveably mounted:
using a robotic arm; or
on a gantry which has both a slide allowing to move it along the horizontal axis x of the working tray and a slide allowing to move it along the horizontal axis y of the working tray; or
on a gantry having at least one scraping blade in order to allow the displacement thereof along the horizontal advance axis x of the scraping blade, said gantry also comprising a slide allowing to move it along the horizontal axis y.
